(19) United States
(12) Patent Application Publication
(10) Pub. No.: US 2012/0244280 A1
(43) Pub. Date: Sep. 27, 2012

(54) MULTI-STEP METHOD FOR PRODUCING ALKALI-RESISTANT ANODIZED ALUMINUM SURFACES

(75) Inventor: Gabriele HECHT, Nettetal (DE)

(73) Assignee: Henkel AG & Co. KGaA, Duesseldorf (DE)

(21) Appl. No.: 13/444,937

(22) Filed: Apr. 12, 2012

Related U.S. Application Data
(63) Continuation of application No. PCT/EP2010/065546, filed on Oct. 15, 2010.

(30) Foreign Application Priority Data
Oct. 16, 2009 (DE) 10 2009045762.3

(51) Int. Cl. B05D 5/00; B05D 3/10; B05D 7/22

(52) U.S. Cl. 427/239

(57) ABSTRACT

The present invention relates to a multi-stage method for producing acid- and alkali-resistant, high-gloss anodized aluminum surfaces. In the method according to the invention, in a first step the anodized surface of aluminum and/or alloys of aluminum is compacted by bringing it into contact with an aqueous composition (A) containing water-soluble alkali silicates having a mol ratio of SiO₂:M₂O of at least 2:1 and no more than 4:1, the alkali metal atoms M being selected from the group consisting of Li, Na and/or potassium, and being subsequently post-treated with an acid aqueous composition (B) containing water-soluble inorganic compounds of zirconium and/or titanium and/or water-soluble fluoro complexes of silicon, preferably water-soluble compounds of zirconium and/or titanium, in particular of zirconium, and optionally water-soluble inorganic fluorine compounds releasing fluoride ions, the mol ratio of the total number of all elements of zirconium, titanium and/or silicon to fluorine in the acid aqueous composition (B) being preferably no greater than 1:4.

The present invention relates to a multi-step method for producing acid- and alkali-resistant, high-gloss anodized aluminum surfaces. In the method according to the invention, the anodized surface of aluminum and/or alloys of aluminum is sealed in a first step by bringing it into contact with an aqueous composition (A) containing water-soluble alkali silicates having a molar ratio of SiO₂:M₂O of at least 2:1 and no more than 4:1, wherein the alkali metal atoms M are selected from Li, Na and/or potassium, and is subsequently post-treated with an acidic aqueous composition (B) containing water-soluble inorganic compounds of zirconium and/or titanium and/or water-soluble fluoro complexes of silicon, preferably water-soluble compounds of zirconium and/or titanium, in particular of zirconium, and optionally water-soluble inorganic fluorine compounds which release fluoride ions, wherein the molar ratio of the total number of all the elements zirconium, titanium and/or silicon to fluorine in the acidic aqueous composition (B) is preferably no greater than 1:4.

The electrochemical production of oxide layers on aluminum is a method for producing anticorrosive and/or decorative coatings on aluminum materials which is widespread in the prior art (aluminum anodizing process). Electrolytically produced covering layers of aluminum oxide protect the aluminum substrate from corrosion and weathering and additionally increase the surface hardness and wear resistance of components made from the anodized aluminum materials.

Different methods of anodizing aluminum are described, for example, in Ullmanns Enzyklopädie der technischen Chemie, 5^{th} edition, vol. 9 (1987), pp. 174-176, and are generally known. For the anodizing of aluminum materials, depending on the electrolyte used, standardized methods now exist which each offer specific technical advantages relating to the application, such as anodizing in sulfuric acid (Eloxal GS), chromic acid (Bengough-Stuart), phosphoric acid (Boeing) or oxalic acid (Eloxal GX). In the Eloxal GS method, current densities of 0.5-3 A/dm² are applied to the workpiece at a voltage of 18-21 V, the bath temperature generally being 10-25° C. By means of the Eloxal GS method, oxide layer thicknesses in the range of approx. 30-50 μm can be established. In all of the methods for anodizing aluminum, a maximum oxide layer thickness is always achieved which is predetermined on the one hand by the dissolution kinetics in the electrolyte used and on the other hand by the kinetics of formation of the oxide layer as a function of the bath voltage.

The oxide layers produced in an anodizing process form a barrier layer against corrosive media on the metallic base material, the barrier effect being ensured only by a thin compact oxide layer on the material side, which makes up only 2% of the overall oxide layer. By far the greatest part of the oxide layer is amorphous and porous and therefore offers no effective protection against aggressive media. The porosity of the freshly produced oxide layer can be advantageous for improving the adhesion of organic covering layers on the anodized material, but it is a serious disadvantage for the use of aluminum components in strongly corrosive environments. For example, these oxide layers are not suitable as barrier layers on aluminum wheel rims in the automotive sector, which are exposed to constant weathering or come into contact with alkaline cleaners in car washes. For this reason, the anodized components are first post-treated in aqueous media to effect a sealing of the pores by hydrolysis of the electrolytically obtained oxide layer. This process, which follows anodizing, is referred to in technical language as compacting or sealing. The compacting of the porous oxide layer can be carried out at different bath temperatures of the aqueous medium (cold sealing in the presence of metal catalysts/hot sealing) and has the effect of converting it to a compact oxide with a boehmite structure. As a result of this compacting process, the corrosion resistance of the oxide coating increases significantly, particularly in the pH range of 5-8 (T. W. Jelinek, Oberflächenbehandlung von Aluminium, Eugen G. Leuze Verlag, 1997, chapter 6.1.3.1).

For a rapid and effective sealing of the electrolytic aluminum oxide layer, inorganic compounds are often added to the sealing bath, which accelerate the hydrolysis of the porous aluminum oxide layer and bring about an additional oxide layer structure or at least a surface modification of the oxide layer. Thus, sealing baths in the prior art can contain water-soluble silicates for an additional increase in the corrosion resistance of the oxide layer (U.S. Pat. No. 6,686,053) or for a hydrophilizing of the material surface in the production of lithographic plates (U.S. Pat. No. 3,181,461, U.S. Pat. No. 2,714,066).

In these fields of application, sealing the anodized aluminum surfaces with aqueous, silicate-containing compositions is often the method of choice owing to the strong affinity of aluminum and silicon to form mixed oxides. In this method of sealing, the pores in the anodized aluminum oxide layer are sealed by the formation of mixed oxides of silicon and aluminum. At the same time, the anodized surface of the material is hydrophilized by the formation of a silicon-rich covering layer, which is desirable in particular for methods of producing lithographic plates.

A further improvement, especially in terms of the corrosion resistance of aluminum surfaces, is achieved in the prior art by the addition of water-soluble complex compounds of the elements zirconium and/or titanium (EP 0 193 964) and of dispersed particulate silicon and/or aluminum oxides (EP 1 064 332) to the silicate-containing sealing baths.

Regardless of the already existing methods of sealing anodized aluminum surfaces, a need exists to prevent the corrosive dissolution of the sealed anodic aluminum oxide layers in highly alkaline media. Contact of sealed aluminum surfaces with highly alkaline media takes place, for example for car bodies and car wheel rims that are manufactured from aluminum materials, in car washes in which alkaline cleaners with pH values in the range of 11.5-13.5 are applied onto the cars. The proportion of aluminum material in car manufacture is increasing and it is already an important component of modern car bodies today. The car industry has therefore issued high quality requirements for the alkali stability of surface-treated aluminum components, compliance with which is monitored by means of special test standards. Up to the present time, only a few methods of sealing anodized aluminum surfaces meet the specifications set by the car industry, and so interest in novel methods of further improving the alkali stability of the sealed oxide layer of aluminum components is high. The Offenlegungsschrift EP 1 873 278 teaches a method for increasing the alkali resistance of anodized aluminum surfaces, in which already sealed aluminum surfaces, which therefore have a high compaction ratio of at least 90%, are post-treated with an aqueous silicate-containing composition.

Likewise DE 1 521 664 discloses first the sealing of the aluminum oxide layer using alkaline aqueous solutions containing metal salts and a subsequent post-sealing with a silicate-containing composition.

It is evident that, while the methods disclosed in the prior art for compacting anodized aluminum surfaces do in part provide satisfactory results in terms of the alkali resistance of the surface treated in this way, on the other hand, however, they do not prevent an undesirable tarnishing of the aluminum surfaces, which represents an irreversible dulling of the surface, which means a loss of the desired high reflectivity of the anodized surfaces. In addition, methods of compacting known in the prior art often provide treated aluminum components having insufficient resistance of the anodized surfaces when exposed alternately to strongly acidic and strongly alkaline media. However, precisely the maintenance of the barrier properties of the anodized aluminum components during alternating exposure to media with markedly different pH values is currently increasingly being demanded of OEMs in the automotive and architectural sectors and a corresponding quality of the aluminum components is sought.

The object of the present invention accordingly lies in providing an alternative method of sealing and/or post-treating sealed anodized aluminum components, which improves the alkali and acid resistance of the aluminum surfaces compared with the prior art and at the same time prevents tarnishing of the compacted components, i.e. the loss of the gloss properties of the aluminum surface.

Surprisingly, it has been shown that a high alkali and acid resistance of anodized aluminum surfaces can be produced in a multi-step process, in which the anodized surface of aluminum and/or alloys of aluminum passes through at least the following process steps consecutively:
i) sealing of the anodized aluminum surface by bringing it into contact with an aqueous composition (A) containing water-soluble alkali silicates having a molar ratio of SiO₂:M₂O of at least 2:1 and no more than 4:1, wherein the alkali metal atoms M are selected from Li, Na and/or potassium;
ii) treating the aluminum surface by bringing it into contact with an acidic aqueous composition (B) containing
   a) water-soluble inorganic compounds of zirconium and/or titanium and/or water-soluble fluoro complexes of silicon, preferably water-soluble compounds of zirconium and/or titanium, in particular of zirconium.

The tarnishing of anodized aluminum surfaces compacted and post-treated in the method according to the invention is completely suppressed, so that the pronounced high gloss of components treated according to the invention is retained permanently.

Anodized aluminum surfaces are understood according to the invention as those surfaces of aluminum that have an aluminum oxide layer of at least 1 μm thickness after electrochemical anodizing methods known in the prior art. As aluminum materials the surface of which is present in anodized form, high-purity aluminum with an aluminum content of at least 99 wt. % and aluminum alloys with an aluminum content of at least 90 wt. % can be used in the method according to the invention. Preferred alloying elements are copper, manganese, titanium, silicon, zinc and magnesium.

In the method according to the invention, it is preferred for compacting the aluminum oxide layer in step i) to use those aqueous compositions (A) that contain at least 0.1 wt. %, particularly preferably at least 0.5 wt. %, more particularly preferably at least 2 wt. %, but no more than 8 wt. %, particularly preferably no more than 6 wt. % of water-soluble alkali silicates calculated as SiO₂. By means of a minimum quantity, it is ensured on the one hand that the sealing process runs at an adequate compacting rate and on the other hand a surface modification takes place through the formation of a mixed oxide containing silicon and aluminum. Higher proportions of water-soluble silicates bring about no further improvement in this respect and are therefore not preferred from an economic point of view.

Optimum conditions for the compacting process in step i) of the multi-step method according to the invention are achieved by bringing the aqueous silicate-containing composition (A) into contact with the anodized aluminum surface at temperatures of at least 30° C., particularly preferably at least 50° C., but at temperatures no higher than 80° C., particularly preferably at temperatures no higher than 70° C., preferably for at least 60 seconds but no more than 10 minutes.

In principle, within the framework of the present invention, it is advantageous if the treatment with the aqueous composition (A) is carried out for a sufficient period until the anodized aluminum surface is at least 90% and preferably at least 95% sealed according to the dye spot test of DIN EN 12373-4 after process step i). This minimum level of sealing after step i) of the method according to the invention is preferred, since in this case the mixed oxide of the elements silicon and aluminum close to the surface has already formed sufficiently for the post-treatment with the aqueous composition (B) to be able to achieve an effective conversion of this oxide layer to an alkali-resistant, high-gloss sealing of the aluminum surface.

The degree of sealing or compacting of the aluminum oxide layer can be determined photometrically using the dye spot test in accordance with DIN EN 12373-4. Here, the dyeability or dye absorption capacity of the anodized surface after the sealing in step i) of the method according to the invention is determined photometrically by means of UV-vis reflection spectroscopy and compared with the dyeability of the freshly anodized surface. In the dye spot test, the anodized aluminum surface is dyed after a defined pretreatment using dye in accordance with DIN EN 12373-4. The test area is wetted with an acid solution (25 ml/l sulfuric acid, 10 g/l KF), the acid solution on the test area is washed off after precisely one minute and the test area is then dried. The test area is then wetted with dye solution (5 g/l Sanodal Blue), which is left to act for one minute. After rinsing under running water, the colored test area is freed of loosely adhering dye by rubbing using a mild powder cleaner. After drying the surface, a relative reflection measurement can be carried out. The dyeing of the surface correlates directly with the degree of sealing of the aluminum oxide layer. A sealed oxide layer possesses the lowest dye absorption capacity, while the open-pored, unsealed oxide layer can absorb the dye well. The quantifying of the degree of sealing in step i) of the method according to the invention can accordingly be performed by measuring the residual reflectivity of the aluminum surface treated according to step i). The residual reflectivity is given as the ratio of reflection intensity measured with a UV-vis photometer (e.g. Micro Color laboratory test instrument from Dr. Lange) on an aluminum surface treated according to process step i) to reflection intensity of a freshly anodized aluminum surface measured with a UV-vis photometer. The ability of the aluminum oxide to absorb dye is directly dependent on the free surface of the porous aluminum oxide layer, so that the free surface and the photometrically determined reflection intensity correlate with one another in a way that enables the degree of sealing to be determined quantitatively:

$$SR = ( 1 - \frac{{S}_{seal} - {S}_{geom}}{{S}_{anod} - {S}_{geom}} ) \times 100 \% ≅ ( 1 - \frac{{R}_{seal}}{{R}_{anod}} ) \times 100 \% \qquad ( I )$$

with S_{anod}, R_{anod}: free surface and reflection intensity of the anodized aluminum surface;
with Sₛₑₐₗ, Rₛₑₐₗ: free surface and reflection intensity of the anodized aluminum surface after step i) of the method according to the invention;
with S_{geom}: geometric surface (measurement area of the photometer);
with SR: degree of sealing in %

From a technical point of view, anodized aluminum surfaces are considered to be completely sealed when their degree of sealing is at least 95% according to the photometric method given above and according to formula (I).

In addition to converting the compacted oxide surface of the aluminum material into an acid- and alkali-resistant and high-gloss seal, in the post-treatment with the aqueous composition (B) in step ii) the water repellency of the surface can be adjusted. High water repellency provides the aluminum material with stain-resistant properties and is also advantageous for cleaning aluminum components, meaning that water-repellent surfaces can be freed from stains very readily by surfactant-containing alkaline cleaners as typically used for cars.

To adjust a water-repellent surface, in the method according to the invention those post-treatment baths which additionally contain water-soluble inorganic fluorine compounds that release fluoride ions are preferred in process step ii).

Water-soluble compounds that release fluoride ions are understood according to the invention to be those compounds that dissociate in the aqueous composition (B) to an extent that the proportion of fluoride in composition (B) can be detected in a test sample of the water-soluble, fluoride-releasing compound of 10 ppm, based on the element fluorine, by means of ion-selective fluoride electrodes that are common in the prior art. These fluoride-releasing compounds are, for example, ammonium bifluoride, hydrogen fluoride or complex metal fluorides, such as H₂ZrF₆, H₂TiF₆ or H₂SiF₆.

It is evident that water-repellent surfaces are formed in the method according to the invention in particular when a high relative proportion of fluorine is present in relation to the elements zirconium, titanium and/or silicon and the molar ratio of the total number of all the elements zirconium, titanium and/or Si to fluorine is no greater than 1:4, preferably no greater than 1:6. In the case of very high relative proportions of fluorine, as a result of the high relative free fluoride proportion that is then also present, the dissolution of the mixed oxide of silicon and aluminum produced near the surface in sealing step i) can dominate. Accordingly in step ii) of the method according to the invention, those compositions (B) are preferred of which the molar ratio of the total number of all the elements zirconium, titanium and/or silicon to fluorine is no less than 1:12 and particularly preferably no less than 1:8.

In particular, in connection with this, it is preferred that in step ii) of the method according to the invention, those water-soluble inorganic compounds that represent fluoro complexes of the metals zirconium, titanium and/or silicon are contained in the aqueous composition (B), particularly preferably fluoro complexes of zirconium and/or titanium, in particular fluoro complexes of zirconium, the molar ratio of the total number of all the elements zirconium, titanium and/or silicon to fluorine in the composition (B) being no greater than 1:4.

Within the framework of the present invention, for an adequate conversion of the compacted anodized oxide layer of the aluminum material to an acid- and alkali-resistant, high-gloss seal in step ii), preferably in total at least 0.2 mmol/l, particularly preferably at least 2 mmol/l of the elements zirconium, titanium and/or silicon are contained in the aqueous composition (B) in the form of water-soluble compounds. From an economic point of view, preferably in total no more than 10 mmol/l and preferably no more than 8 mmol/l of the elements zirconium, titanium and/or silicon should be contained in the composition (B) in the form of water-soluble inorganic compounds, since concentrations this high bring no additional technical advantage.

Moreover, the pH value of the acidic aqueous composition (B) is a parameter that affects the conversion of the compacted anodized aluminum surface to an acid- and alkali-resistant, high-gloss sealing of the material in step ii). It is evident that in process step ii) a pH value of no less than 2 and no greater than 6 is preferred, and in particular the pH value of the acidic aqueous composition (B) should be no greater than 3.

To adjust and stabilize the pH value of the acidic aqueous composition (B) in step ii) of the method according to the invention, a buffer system can additionally be contained, wherein buffer systems should preferably be used which are distinguished by a protolysis equilibrium with a pKₐ value of no less than 2 and no more than 4, particularly preferably no more than 3. A particularly preferred buffer system for the acid aqueous composition (B) is ammonium acetate.

The post-treatment of the compacted anodized aluminum surface in step ii) can be carried out even at room temperature. The temperature of composition (B) in step ii) is preferably at least 20° C. and is preferably no greater than 40° C. The post-treatment times in step ii) of the method according to the invention are preferably at least 5 min and are preferably no longer than 15 min.

According to the invention, a method is further preferred in which, after process step i) and before process step ii), a drying step additionally takes place at a temperature of at least 100° C. and preferably of at least 140° C., but no more than 300° C. As a result of this, the sealing of the porous aluminum oxide layer compacted in step i) is continued further, so that the anodized surfaces already have very good resistance to alkalis.

A rinsing step immediately after step i) and before a drying step is, on the other hand, a hindrance to complete compacting and also brings about a partial washing out of silicates from the anodized aluminum surface. However, silicatization is necessary for the production of alkali-resistant and optically defect-free aluminum oxide surfaces in the method according to the invention.

Process step ii) can be immediately followed by a drying step in the method according to the invention, with or without an intermediate rinsing step.

If in the method according to the invention a rinsing step takes place immediately after the post-treatment in step ii), then a hot water rinsing step at a temperature of at least 60° C. is preferred, in particular of at least 80° C., but the temperature of the hot rinse should be no more than 95° C. for process engineering reasons.

### EXEMPLARY EMBODIMENTS

For the examples listed here, AA 5505 aluminum plates (99.9 at. % Al, 0.1 at. % Mg) were anodized in a sulfuric acid electrolyte (200 g/l H₂SO₄) at an electrolysis voltage of 16 V and a current density of 1.5 A/dm² for 20 min. The aluminum plates anodized in this way had an oxide layer thickness of 8-10 μm.

The anodized aluminum plates were then sealed in a multi-step process (Tab. 1) and subsequently evaluated qualitatively in accordance with various test methods (Tab. 2) with regard to their acid and alkali resistance and the gloss properties of the surface.

It can be seen from Table 2 that, in the method according to the invention (E1-E6), good resistance of the treated aluminum oxide layer is always observed under the conditions of the AHA test and glossy surfaces always result, the high reflectivity of which is permanent. It is evident, however, that an almost complete compacting of the anodized plates in the first process step (1st stage) is particularly advantageous for the acid and alkali resistance of the plates treated according to the invention (E1). A high proportion of silicates in the sealing bath of the first process step accordingly has, for the same treatment period, just as positive an effect on the compacting and thus on the effectiveness of the second treatment stage as the drying of the plates after the sealing bath of the first process step (cf. E1 and E2, and E1 and E4).

The hydrophilicity of the anodized plates treated in the method according to the invention can be adjusted by means of the proportion of fluoride in the post-treatment (2^{nd} stage). Fluoride-free post-treatment baths give hydrophilic surfaces (E3) while, independently of a subsequent drying step, strongly water-repellent aluminum surfaces are formed in fluoride-containing baths (E1, E5).

The comparative tests C1 and C2 prove that both a silicate-free sealing (C2) of the surfaces in the first treatment stage and a Zr-free post-treatment (C2) in similar multi-step processes do not give satisfactory results, with either the acid and alkali stability (C1) being deficient or the surfaces acquiring a grayish tarnish and losing their gloss after just a short time (C2). A post-treatment with hexafluorosilicic acid also gives satisfactory results in terms of the AHA test and gloss properties (E6).

TABLE 1
Multi-step method for compacting anodized aluminum plates AA 5505

| | 1^{st} stage^{a} | Drying^{b} | 2^{nd} stage^{c} | Drying^{b} |
|---|---|---|---|---|
| E1 | 3.5 wt. % SiO₂ | yes | 0.3 wt. % H₂ZrF₆ | yes |
| | Na-water glass 37/40 | | | |
| E2 | 0.8 wt. % SiO₂ | yes | 0.3 wt. % H₂ZrF₆ | yes |
| | Na-water glass 37/40 | | | |
| E3 | 3.5 wt. % SiO₂ | yes | 0.33 wt. % ZrO(NO₃)₂ | yes |
| | Na-water glass 37/40 | | | |
| E4 | 3.5 wt. % SiO₂ | yes (50° C.; 10 min) | 0.3 wt. % H₂ZrF₆ | yes |
| | Na-water glass 37/40 | | | |
| E5 | 3.5 wt. % SiO₂ | yes | 0.3 wt. % H₂ZrF₆ | yes (20° C.; 20 min) |
| | Na-water glass 37/40 | | | |
| E6 | 3.5 wt. % SiO₂ | yes | 0.21 wt. % H₂SiF₆ | yes |
| | Na-water glass 37/40 | | | |
| C1 | Hot water sealing^{d} | no | 0.3 wt. % H₂ZrF₆ | yes |
| C2 | 3.5 wt. % SiO₂ | yes | deionized water | yes |
| | Na-water glass 37/40 | | | |

^{a}60° C.; 5 min
^{b}160° C.; 10 min
^{c}containing 0.13 wt. % ammonium acetate apart from E3; treatment at 25° C. for 5 min; subsequent rinse step with deionized water
^{d}deionized water at 96-98° C.; 24 min

TABLE 2
Acid-heat resistance and gloss properties of anodized aluminum
plates AA 5505 after multi-step treatment according to Table 1

| | Degree of | | | Water |
|---|---|---|---|---|
| | sealing¹ | AHA test² | Gloss³ | repellency⁴ |
| E1 | 98% | 1 | 1 | 1 |
| E2 | 92% | 3 | 2 | 1 |
| E3 | 98% | 1 | 1 | 4 |
| E4 | 90% | 3 | 2 | 3 |
| E5 | 98% | 1 | 1 | 1 |
| E6 | 98% | 1 | 1-2 | 1 |
| C1 | 88% | 4 | 2 | 4 |
| C2 | 98% | 1-2 | 4 | 3 |

¹Immediately before the second treatment stage according to dye spot test of DIN EN 12373-4 and equation (I)
²Acid-heat-alkali resistance according to the following test sequence:
10 min immersion in 0.1M hydrochloric acid solution (pH 1) washing in H₂O and drying
1 h heat ageing at 40° C. (continue with the test sequence without cooling)
10 min immersion in solution of 12.7 g NaOH, 2 g Na₃PO₄ and 0.33 g NaCl (pH 13.5)
washing in H₂O and drying
AHA resistance is present if, after immersion of half of the test plate according to the test sequence, no immersion boundary can be visually detected.
1 not visible
2 immersion boundary visible
3 partly corroded surface in immersion area
4 strongly corroded surface in immersion area
³Optical evaluation of gloss properties 24 h after end of multi-step treatment:
1: high gloss
2: glossy
3: matt
4: gray coloring
⁴Evaluated as dewetting of an adhering water film after immersion in deionized water:
1 rapid dewetting
2 dewetting
3 largely adhering wet film
4 adhering wet film

1. A method for increasing the alkali resistance of anodized surfaces of aluminum and/or alloys of aluminum in which at least the following process steps are performed consecutively:
i) sealing an anodized aluminum surface by bringing the anodized aluminum surface into contact with an aqueous composition (A) containing water-soluble alkali silicates having a molar ratio of SiO₂:M₂O of at least 2:1 and no more than 4:1, wherein “M” represents alkali metal atoms Li, Na and/or potassium;
ii) treating the anodized aluminum surface by bringing said anodized aluminum surface into contact with an acidic aqueous composition (B) containing
a) water-soluble inorganic compounds of zirconium and/or titanium and/or water-soluble fluoro complexes of silicon,
b) optionally water-soluble inorganic fluorine compounds which release fluoride ions, wherein the acidic aqueous composition (B) has a molar ratio of the total number of all the zirconium, titanium and/or silicon to fluorine in the acidic aqueous composition (B) is no greater than 1:4.

2.-10. (canceled)

11. The method according to claim 1, wherein the alkali silicates are present in the aqueous composition (A) in amounts of no greater than 8 wt. %, but at least 0.1 wt. % based on SiO₂.

12. The method according to claim 1, wherein the anodized aluminum surface is at least 90% sealed according to dye spot test of DIN EN 12373-4 after process step i).

13. The method according to claim 1, wherein the molar ratio of zirconium, titanium and/or silicon to fluorine in the acidic aqueous composition (B) in process step ii) is no less than 1:12.

14. The method according to claim 1, wherein total concentration of all of the zirconium, titanium and/or silicon in the acidic aqueous composition (B) in process step ii) is at least 0.2 mmol/l, but no more than 10 mmol/l.

15. The method according to claim 1, wherein the acidic aqueous composition (B) in process step ii) contains fluoro complexes of zirconium, titanium and/or silicon.

16. The method according to claim 1, wherein the acidic aqueous composition (B) in process step ii) has a pH value of no less than 2 and no greater than 6.

17. The method according to claim 1, wherein the acidic aqueous composition (B) in process step ii) additionally contains a buffer system with a pKₐ value of no less than 2 and no more than 4.

18. The method according to claim 17, wherein the buffer system is selected from ammonium acetate.

19. The method according to claim 1, wherein after process step i) and before process step ii) a drying step takes place at a temperature of at least 100° C. but no more than 300° C.

20. The method according to claim 1, wherein the alkali silicates are present in the aqueous composition (A) in amounts of no greater than 6 wt. %, but at least 2 wt. % based on SiO₂.

21. The method according to claim 1, wherein the anodized aluminum surface is at least 95% sealed according to dye spot test of DIN EN 12373-4 after process step i).

22. The method according to claim 1, wherein the molar ratio of zirconium, titanium and/or silicon to fluorine in the acidic aqueous composition (B) in process step ii) is no less than 1:8.

23. The method according to claim 1, wherein total concentration of all the zirconium, titanium and/or silicon in the acidic aqueous composition (B) in process step ii) is at least 2 mmol/l, but no more than 8 mmol/l.

24. The method according to claim 1, wherein the acidic aqueous composition (B) in process step ii) contains fluoro complexes of the zirconium, titanium and/or silicon, wherein the molar ratio of the total number of all the zirconium, titanium and/or silicon to fluorine in the acidic aqueous composition (B) is no greater than 1:4.

25. The method according to claim 24, wherein the acidic aqueous composition (B) in process step ii) contains fluoro complexes of zirconium, wherein the molar ratio of the zirconium to fluorine in the acidic aqueous composition (B) is no greater than 1:4.

26. The method according to claim 1, wherein:
a. the alkali silicates are present in the aqueous composition (A) in amounts of no greater than 6 wt. %, but at least 2 wt. % based on SiO₂;
b. the acidic aqueous composition (B) in process step ii) has a pH of 2 to 6; contains fluoro complexes of zirconium, titanium and/or silicon; total concentration of all the zirconium, titanium and/or silicon in the acidic aqueous composition (B) is 2 mmol/l to 8 mmol/l, and the molar ratio of zirconium, titanium and/or silicon to fluorine in the acidic aqueous composition (B) in process step ii) is no less than 1:8.
